(19) United States
(12) Patent Application Publication
(10) Pub. No.: US 2025/0065390 A1
(43) Pub. Date: Feb. 27, 2025

(54) MAGNESIUM ALLOY MOLDED ARTICLE AND MOLDING DEVICE THEREOF

(71) Applicant: MASSIVE LAB INC., Jeollanam-do (KR)

(72) Inventor: KYUNGSUN YANG, Seoul (KR)

(21) Appl. No.: 18/848,588

(22) PCT Filed: May 30, 2023
(86) PCT No.: PCT/KR2023/007345

§ 371 Date: Sep. 19, 2024

(30) Foreign Application Priority Data
May 31, 2022 (KR) 10-2022-0067250
Jan. 30, 2023 (KR) 10-2023-0012032

(51) Int. Cl. B21C 23/00

(52) U.S. Cl. CPC B21C 23/002

(57) ABSTRACT

A magnesium alloy molding device includes a support unit supporting a processing target to be rotatable, at least one heater module detachably disposed on an outer circumferential surface of the processing target and heating the processing target, a rotating unit opposite to the support unit and rotating the processing target supported by the support unit, and at least one roller unit applying a pressure to the processing target while being moved in an axial direction of the processing target and rotated along the outer circumferential surface of the processing target

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2023/007345, filed May 30, 2023, which claims priority to the benefit of Korean Patent Application Nos. 10-2022-0067250 filed on May 31, 2022 and 10-2023-0012032 filed on Jan. 30, 2023, in the Korean Intellectual Property Office, the entire contents of which are incorporated herein by reference.

### BACKGROUND

### 1. Technical Field

The present disclosure relates to a magnesium alloy molded article and a molding device thereof.

### 2. Background Art

Magnesium alloy is a lightweight metal material having low density among available structural materials, and is in the spotlight due to its excellent feature such as a high specific strength, machinability, or vibration absorption. In addition, the magnesium alloy may also be used for a special purpose by adjusting an alloy ratio according to each application field, and research is actively being conducted to utilize the magnesium alloy in various fields.

However, the magnesium alloy has a relatively low mechanical property, and many efforts are thus being made to improve the strength and ductility of a magnesium alloy processed material through various methods.

### SUMMARY

An object of the present disclosure is to provide a magnesium alloy molded article and a molding device thereof.

According to an embodiment of the present disclosure, provided is a magnesium alloy molding device including: a support unit supporting a processing target to be rotatable; at least one heater module detachably disposed on an outer circumferential surface of the processing target and heating the processing target; a rotating unit opposite to the support unit and rotating the processing target supported by the support unit; and at least one roller unit applying a pressure to the processing target while being moved in an axial direction of the processing target and rotated along the outer circumferential surface of the processing target.

The roller unit may have a predetermined incline relative to the processing target.

The roller unit may further include a roller moving unit moved forward or backward in the axial direction of the processing target.

The roller unit may further include a roller rotating unit rotating the roller unit along the outer circumferential surface of the processing target.

The device may further include a compensation unit inserted into the processing target to compensate for shaking of the processing target.

The device may further include a heater heating the processing target to a predetermined temperature.

According to an embodiment of the present disclosure, provided is a magnesium alloy molded article, which is achieved by molding a processing target heated to a predetermined temperature by a magnesium alloy molding device, wherein the magnesium alloy molding device includes: a support unit supporting the processing target to be rotatable; at least one heater module detachably disposed on an outer circumferential surface of the processing target and heating the processing target; a rotating unit opposite to the support unit and rotating the processing target supported by the support unit; and at least one roller unit applying a pressure to the processing target while being moved in an axial direction of the processing target and rotated along the outer circumferential surface of the processing target.

The predetermined temperature may be 200° C. to 450° C.

A rotation speed of the rotating unit may be 300 to 1200 revolutions per minute (RPM).

A movement speed of the roller unit may be 2 to 14 mm/s in the axial direction of the processing target.

A molding amount of the processing target in a diameter direction may be 0.05 to 1.5 mm.

As set forth above, according to the present disclosure, it is possible to provide the magnesium alloy molding device molding the magnesium alloy.

According to an embodiment of the present disclosure, it is possible to provide the highly reliable magnesium alloy molded article securing the mechanical property that may replace the aluminum material.

### BRIEF DESCRIPTION OF THE DRAWINGS

FIG. 1 is a schematic configuration diagram of a magnesium alloy molding device according to an embodiment of the present disclosure.

FIG. 2 is a schematic cross-sectional diagram of the magnesium alloy molding device according to an embodiment of the present disclosure.

FIG. 3 shows a cross-section of an extruded magnesium alloy.

FIG. 4 shows a cross-section of a magnesium alloy molded article acquired by performing cold molding on the extruded magnesium alloy.

FIG. 5 shows a cross-section of the magnesium alloy molded article acquired by performing hot molding on the extruded magnesium alloy.

FIG. 6 is a perspective diagram of the magnesium alloy molded article molded by the magnesium alloy molding device according to an embodiment of the present disclosure.

### DETAILED DESCRIPTION

Hereinafter, a magnesium alloy molded article and a molding device thereof according to embodiments of the present disclosure will be described in detail with reference to the accompanying drawings.

It is to be noted that in giving reference numerals to components of the accompanying drawings, the same components are represented by the same reference numerals even though the components are illustrated in different drawings. In addition, a detailed description of well-known features or functions will be ruled out in order not to hinder understanding of an embodiment of the present disclosure.

Terms “first”, “second”, A, B, (a), (b), and the like, may be used in describing the components in the embodiments of the present disclosure. These terms are used only to distinguish any component and another component from each other, and the features, sequences, and the like of the corresponding components are not limited to these terms. In addition, unless otherwise defined, all terms used herein, including technical or scientific terms, have the same meanings as those generally understood by a person skilled in the art to which the present disclosure pertains. It should be interpreted that terms defined by a generally used dictionary have the same meanings as their meanings within the context of the related art, and these terms should not be ideally or excessively formally interpreted unless the context clearly dictates otherwise.

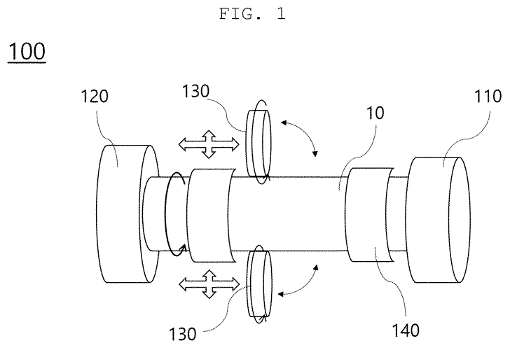

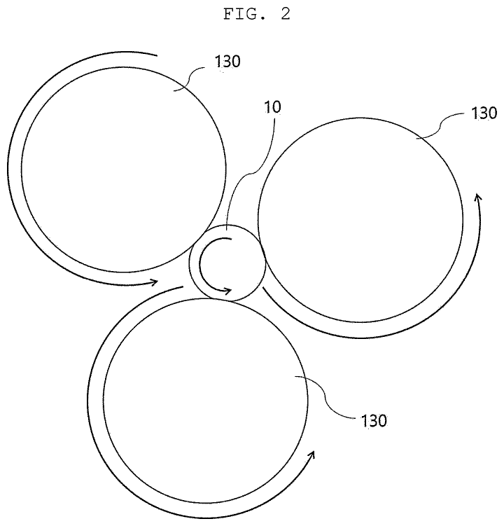

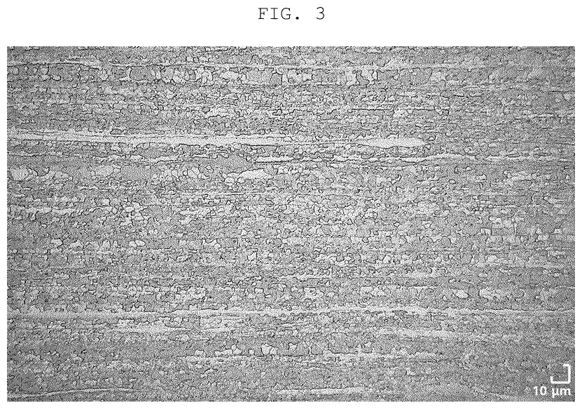

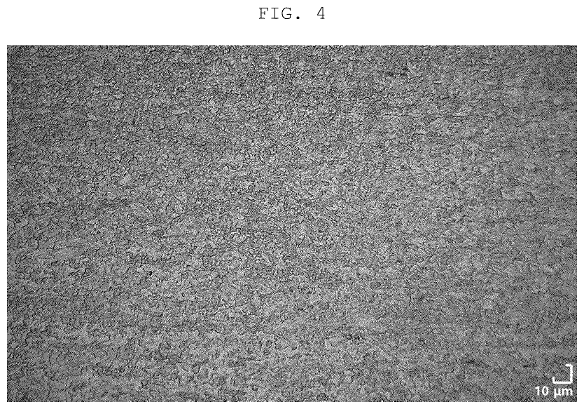

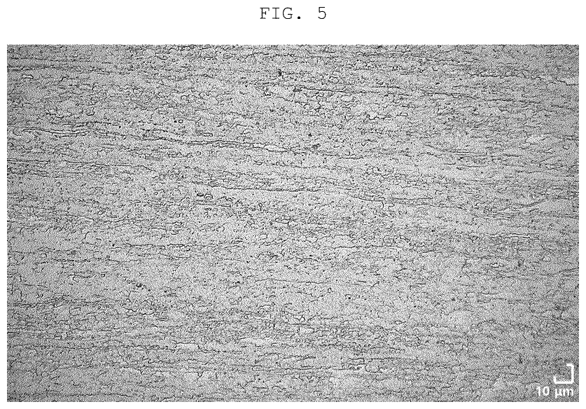

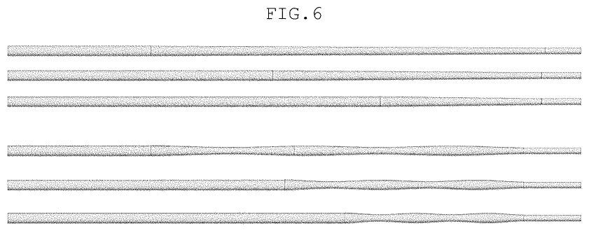

FIG. 1 is a schematic configuration diagram of a magnesium alloy molding device according to an embodiment of the present disclosure; FIG. 2 is a schematic cross-sectional diagram of the magnesium alloy molding device according to an embodiment of the present disclosure; FIG. 3 shows a cross-section of an extruded magnesium alloy; FIG. 4 shows a cross-section of a magnesium alloy molded article acquired by performing cold molding on the extruded magnesium alloy; FIG. 5 shows a cross-section of the magnesium alloy molded article acquired by performing hot molding on the extruded magnesium alloy; and FIG. 6 is a perspective diagram of the magnesium alloy molded article molded by the magnesium alloy molding device according to an embodiment of the present disclosure.

According to FIGS. 1 to 6, a magnesium alloy molding device 100 may include: a support unit 110 supporting a processing target 10 to be rotatable; a rotating unit 120 opposite to the support unit and rotating the processing target 10 supported by the support unit 110 to be rotatable; at least one heater module 140 detachably disposed on an outer circumferential surface of the processing target 10 and heating the processing target 10; and at least one roller unit 130 applying a pressure to the processing target 10 while being moved in an axial direction of the processing target 10 and rotated along the outer circumferential surface of the processing target 10, wherein the roller unit 130 is rotated while having a predetermined incline relative to the processing target 10. The roller unit 130 may have a molding length of 1,000 mm. The processing target 10 may preferably be a magnesium pipe formed by extruding a magnesium billet.

The processing target 10 may be supported by the support unit 110 and rotated by the rotating unit 120. The processing target 10 may have one surface coupled to the rotating unit 120, and the other surface supported by the support unit 110, and the processing target 10 coupled to the rotating unit 120 may be rotated by the rotation of the rotating unit 120. The support unit 110 may be configured to provide a pressure resisting a longitudinal expansion of the processing target 10 while a processing region of the processing target 10 is processed by the roller unit 130. The processing target 10 may undergo plastic deformation during the processing, thereby increasing its length, and the support unit 110 may here provide the pressure resisting the longitudinal expansion of the processing target 10. Each processing target may have different physical properties such as different elongation and hardness, and thus have a different amount of elongation during the processing. Here, the support unit 110 may provide the pressure resisting the longitudinal expansion of the processing target 10 during the processing to thus allow the processing target 10 to maintain a constant length during the processing, thereby having its length that remains the same after the molding.

The roller unit 130 may mold the processing target 10 by applying the pressure thereto while being rotated along the outer circumferential surface of the processing target 10. The roller unit 130 may be moved in the axial direction of the processing target 10 while being rotated along the outer circumferential surface of the processing target 10, and apply the pressure to the processing target 10 by changing the molding amount that determines a cross-sectional area of the processing target 10 based on a user selection. The roller unit 130 may be moved in the axial direction of the processing target 10, thus forming various shapes of the magnesium alloy molded article, such as taper and wave. A diameter of the roller unit 130 may have a predetermined length, preferably 20 to 300 mm.

The roller unit 130 may be inclined at a predetermined angle, and the processing target 10 may have the various shapes based on the incline. The inclination angle may be determined based on a selection of a person skilled in the art.

The rotating unit 120 may include a rotating drive shaft for rotating the rotating unit, and the rotating drive shaft may be rotated by a driving motor. For example, the driving motor may be a stepping motor, and is not limited thereto.

The roller unit 130 is an element applying the pressure to the processing region of the processing target 10 for the processing, and may be fastened to, for example, a tool holder (not shown). The roller unit 130 may be rotatable in the magnesium alloy molding device 100, and thus be rotated by a frictional force when applying the pressure to the processing target 10 for processing the processing target. The magnesium alloy molding device 100 may be configured to be moved in the axial direction (horizontal direction in FIG. 1) and radial direction (vertical direction in FIG. 1) of the processing target 10 for the processing.

The roller unit 130 may be a roller in direct contact with the processing target 10 for deforming the processing target 10. The plurality of roller units 130 may be provided, and respectively be arranged at the upper and lower sides of the processing target 10 based on its height. A roller moving unit may be moved forward or backward toward the support unit 110 in the horizontal direction. An adjustment link (not shown) may adjust a position of the roller unit 130 by being linked to the movement of the roller moving unit for the roller unit 130 to be moved toward or away from a central axis of the pressing target 10. The roller moving unit may be configured to move the roller unit 130 forward or conversely to move the roller unit 130 backward, in the horizontal direction of the processing target. To this end, the roller moving unit may be a cylinder or a servo motor disposed in the horizontal direction, and is not limited thereto.

The roller unit 130 may further include a roller rotating unit (not shown) rotating the roller unit along the outer circumferential surface of the processing target 10.

As the rotating unit 120 is rotated, the processing target 10 may be rotated around a longitudinal axis, and the roller unit 130 may press the outer surface of the processing target 10 being rotated, thus processing the processing region of the processing target 10 into a desired tapered shape.

The support unit 110 or the rotating unit 120 may further include a compensation unit (not shown) compensating for shaking of the processing target 10 that occurs during the rotation or processing of the processing target 10. The compensation unit may preferably be a mandrel. The compensation unit may be inserted into the processing target 10 to compensate for the shaking that is caused by the rotation or processing of the processing target 10 to thus reduce a molding error caused by the shaking, thereby increasing molding reliability.

The magnesium alloy molding device may further include the heater module 140 heating the processing target 10 to a predetermined temperature. At least one heater module 140 may be disposed along the outer circumferential surface of the processing target 10 while having the form of a detachable cover, and the heater module 140 mounted at a position requiring the heating among the plurality of heater modules 140 may be selectively driven based on a molding direction or a molding position. The magnesium alloy molding device may overcome a limitation in the molding direction by including the heater module 140. The magnesium alloy molding device may perform its forward, backward, or reciprocating movement based on a molding direction type. In addition, the magnesium alloy molding device may perform a reciprocating stroke, thus having the improved performance and productivity compared to its single stroke. The magnesium alloy molding device may heat the processing target to the predetermined temperature by including the heater module 140, and the predetermined temperature may be 100° C. to 500° C. and preferably 200°° C. to 450° C. Hereinafter, the heater module 140 may heat the processing target at 200° C. to 450° C. because the magnesium alloy has low ductility to thus lower its processability and moldability at a temperature less than 100° C., and a property of the magnesium alloy itself may be changed at a certain higher temperature and a defect may easily occur therein. In addition, the magnesium alloy molding device may use a temperature controller and an actuator to improve its process-based operation, equipment usability, and small-quantity production of a variety of products.

The magnesium alloy molded article may be formed by: extruding a magnesium alloy billet into a pipe having a predetermined strength; heat-treating the extruded magnesium alloy; molding, by the magnesium alloy molding device, the heat-treated magnesium alloy to the predetermined temperature; coating the molded magnesium alloy molded article; and painting the coated magnesium alloy molded article.

### Extruding

A manufacturing method of a magnesium alloy molded article may include the extruding of the magnesium alloy billet. The magnesium alloy billet may be extruded into the pipe shape having the predetermined strength, and the extruded magnesium alloy pipe may preferably have a strength of 350 megapascals (MPa). The extrusion is a process used to provide an object having a fixed cross-sectional contour, and the extrusion process may also increase a material strength. The extruded magnesium alloy article may be a pipe-shaped tube, and the magnesium alloy pipe may preferably have a length of 800 mm, and a diameter of 9.5 mm.

If the extrusion is performed without preheating a die, a material-jamming phenomenon may easily occur, and even when the die is preheated before the extrusion, it may be preferable to adjust a ram speed or perform the extrusion without delay to prevent the die from being excessively cooled during the extrusion. If the die is difficult to be preheated or the ram speed is excessively low, a billet temperature may be continuously decreased to increase an extrusion load and cause the material-jamming phenomenon. As an extrusion ratio is increased, a microstructure may be more refined, which may be inversely proportional to elongation of the material even though securing its improved strength. If the extrusion ratio is excessively low, the material may have an excessively low strength, or may be manufactured unevenly due to a difference in the microstructure of the magnesium alloy extruded material in each portion, and many rough and large grains.

The magnesium alloy may include an alloy such as an aluminum-zinc (AZ) based alloy having Al and Zn as its main additive elements, an aluminum-manganese (AM) based alloy having Al and Mn as its main additive elements, a zirconium-zinc (ZK) based alloy having Zr and Zn as its main additive elements, an aluminum-rare earth (AE) based alloy having Al and rare earths as its main additive elements, a yttrium-rare earth (WE) based alloy having Y and rare earths as its main additive elements, or an alloy having Li (lithium) as its main additive element, and is not limited thereto.

### Heat-Treating

The extruded magnesium alloy pipe may be acquired by the heat-treating. In the extruding, the extruded magnesium alloy pipe may be heat-treated, and the magnesium alloy pipe may have an increased tensile strength through the heat treatment. The increased tensile strength may preferably be approximately 10%.

### Molding

The method may include the molding of the heat-treated magnesium alloy. In order to mold the magnesium alloy pipe, the magnesium alloy may be molded only within a predetermined temperature range. The predetermined temperature may be preferably 200° C. to 450° C. A molding process suitable for the magnesium alloy molded article of the present disclosure may be achieved by a predetermined revolutions per minute (RPM), a predetermined feed speed, and a predetermined molding amount. The feed speed refers to a movement speed of a roller unit in an axial direction of the processing target, and the molding amount refers to a molding amount based on a diameter of the processing target. Preferably, the predetermined RPM may be 300 to 1200 RPM, the predetermined feed speed may be 2 to 10 mm/s, the predetermined molding amount may be 0.02 mm to 10 mm, and are not limited thereto.

For example, a rotation speed of the rotating unit may be 300 to 1200 RPM, and is not limited thereto. The roller unit 130 may be moved forward or backward in an axial direction of the magnesium pipe, and mold the magnesium pipe by applying the pressure to the magnesium pipe while being rotated along an outer circumferential surface of the magnesium pipe. The roller unit 130 may apply the pressure to the processing target 10 while changing the molding amount that determines a cross-sectional area of the processing target 10 based on a user selection.

### Coating and Painting

The magnesium alloy molded article molded in the molding may be coated in the coating and painting, and the magnesium alloy molded article may be achieved by being coated and then painted.

### EXPERIMENTAL EXAMPLE

The magnesium alloy material is heat-treated to manufacture the magnesium alloy molded article. FIG. 4 shows a cross-section of the magnesium alloy molded article in Example 1 before being processed after extruding the magnesium alloy, FIG. 5 shows a cross-section of the magnesium alloy molded article in Example 2 after a cold molding process during the magnesium alloy molding process, and FIG. 6 shows a cross-section of the magnesium alloy molded article in Example 3 after a hot molding process during the magnesium alloy molding process.

### Example 1

The magnesium alloy casting billet is extruded to thus manufacture the magnesium alloy extruded material. Next, the magnesium alloy extruded material is cut and processed to produce a specimen for a compression test, thereby manufacturing a specimen shown in FIG. 4.

### Example 2

The magnesium alloy casting billet, which is the same as Example 1, is extruded to manufacture the magnesium alloy extruded material. The magnesium alloy extruded material is molded and processed by performing the cold molding process thereon, and the magnesium alloy molded article is then cut and processed to produce the specimen for the compression test, thereby manufacturing a specimen shown in FIG. 5.

### Specimen in Example 3

The magnesium alloy casting billet, which is the same as Example 1, is extruded to manufacture the magnesium alloy extruded material. Next, the magnesium alloy extruded material is molded and processed. Here, the molding process is performed under a temperature condition of 150 to 300 degrees during the molding process, and the magnesium alloy molded article is then cut and processed to produce the specimen for the compression test, thereby manufacturing a specimen shown in FIG. 6.

The present disclosure is not necessarily limited to the embodiments described above, and it is apparent to a person skilled in the art to which the present disclosure pertains that the present disclosure may be variously modified and implemented within the range equivalent to the present disclosure. Therefore, the true scope of the present disclosure is defined by the claims set forth below.

1. A magnesium alloy molding device comprising:
a support unit supporting a processing target to be rotatable;
at least one heater module detachably disposed on an outer circumferential surface of the processing target and heating the processing target;
a rotating unit opposite to the support unit, the rotating unit configured for rotating the processing target supported by the support unit; and
at least one roller unit configured for applying a pressure to the processing target while being moved in an axial direction of the processing target and rotated along the outer circumferential surface of the processing target.

2. The device of claim 1, wherein the roller unit has a predetermined incline relative to the processing target.

3. The device of claim 1, wherein the roller unit further includes a roller moving unit moved forward or backward in the axial direction of the processing target.

4. The device of claim 1, wherein the roller unit further includes a roller rotating unit rotating the roller unit along the outer circumferential surface of the processing target.

5. The device of claim 1, further comprising a compensation unit inserted into the processing target to compensate for shaking of the processing target.

6. The device of claim 1, further comprising a heater heating the processing target to a predetermined temperature.

7. A magnesium alloy molded article, which is achieved by molding a processing target heated to a predetermined temperature by a magnesium alloy molding device, the magnesium alloy molding device comprising:
a support unit configured for supporting the processing target to be rotatable;
at least one heater module detachably disposed on an outer circumferential surface of the processing target and heating the processing target;
a rotating unit opposite to the support unit, the rotating unit configured for rotating the processing target supported by the support unit; and
at least one roller unit configured for applying a pressure to the processing target while being moved in an axial direction of the processing target and rotated along the outer circumferential surface of the processing target.

8. The article of claim 7, wherein the predetermined temperature is 200° C. to 450° C.

9. The article of claim 7, wherein a rotation speed of the rotating unit is 300 to 1200 revolutions per minute (RPM).

10. The article of claim 7, wherein a movement speed of the roller unit is 2 to 14 mm/s in the axial direction of the processing target.

11. The article of claim 7, wherein a molding amount of the processing target in a diameter direction is 0.05 to 1.5 mm.
